(19) United States
(12) Patent Application Publication
(10) Pub. No.: US 2026/0336879 A1
(43) Pub. Date: Oct. 29, 2026

(54) PHARMACEUTICAL CONTAINER ASSEMBLIES INCLUDING SEALING ASSEMBLIES FOR LOW TEMPERATURE STORAGE

(71) Applicant: CORNING INCORPORATED, CORNING, NY (US)

(72) Inventors: Dane Alphanso Christie, Painted Post, NY (US); Adam Robert Sarafian, Corning, NY (US); Jiangtao Wu, Corning, NY (US); Wei Xu, State College, PA (US)

(21) Appl. No.: 19/484,282

(22) PCT Filed: May 17, 2024
(86) PCT No.: PCT/US2024/029817

§ 371 Date: Nov. 13, 2025

Related U.S. Application Data
(60) Provisional application No. 63/504,835, filed on May 30, 2023.

(51) Int. Cl. B65D 41/28; A61J 1/14

(52) U.S. Cl. CPC B65D 41/28; A61J 1/1412; B65D 2251/0015; B65D 2251/0075

(57) ABSTRACT

Would the agent still wish to withdraw the priority claim, please provide us with the missing document to prevent the publication of the said priority claim. Otherwise, please clarify.

### CROSS-REFERENCE TO RELATED APPLICATIONS

This application claims the benefit of priority under 35 U.S.C. § 119 of U.S. Provisional Application Ser. No. 63/504,835 filed on May 30, 2023, the content of which is relied upon and incorporated herein by reference in its entirety.

### TECHNICAL FIELD

The present specification generally relates to containers, such as glass containers for storing pharmaceutical compositions and, more particularly, pharmaceutical container assemblies including a sealing assembly cooperating with a glass container to maintain a container closure integrity at relatively low storage temperatures.

### BACKGROUND

Pharmaceutical containers, such as vials and syringes, are typically sealed via a stopper or other closure to preserve the integrity of the contained material. Closures are typically made of synthetic rubbers and other elastomers. Such materials beneficially have modest and/or high permeation resistance and elasticity to facilitate insertion into the container to seal the container's interior. The elasticity of typically-used closure materials, however, may reduce at low temperatures. For example, synthetic rubbers currently in use as material closures may comprise transition temperatures that are greater than or equal to −70 °C and less than or equal to −10 °C. Below the transition temperature, closures constructed of such synthetic rubbers may behave as a solid and be unable to expand elastically to compensate for the relatively large difference between coefficients of thermal expansion of the glass and a crimping cap used to secure the closure to the container. Given this, existing sealing assemblies for pharmaceutical containers may fail at temperatures less than or equal to −20 °C.

Some biological materials (e.g., blood, serum, proteins, stem cells, and other perishable biological fluids) require storage at temperatures below the glass transition temperatures of conventional elastomers to remain useful. For example, certain RNA-based vaccines may require storage at dry-ice temperatures (e.g., approximately −80 °C) or liquid nitrogen temperatures (e.g., approximately −180 °C) to remain active. Such low temperatures may result in dimensional changes in the closure components (e.g., the glass or plastic container, the stopper, an aluminium cap), leading to issues in the integrity of the seal, and potential contamination of the material stored therein.

### SUMMARY

In one embodiment, a pharmaceutical container assembly includes a pharmaceutical container and a sealing assembly. The pharmaceutical container includes: a shoulder; a neck extending from the shoulder; and a flange extending from the neck. The flange includes: an underside surface extending from the neck; an outer surface extending from the underside surface; an upper surface opposite the underside surface, the upper surface extending between the outer surface and an inner surface defining an opening in the pharmaceutical container; and a sealing assembly. The sealing assembly includes: a stopper including an upper portion and an insertion portion, the upper portion comprising an upper surface, the insertion portion including an outer surface. The insertion portion extends from the upper portion. In a sealed state, the insertion portion is inserted into the opening to define a seal between the insertion portion and the inner surface of the flange. In the sealed state, the upper portion extends over the upper surface of the flange and covers the opening. In an unsealed state in which the insertion portion is not inserted into the opening, an outer diameter of a portion of the insertion portion is equal to or greater than 3% and less than or equal to 15% greater than a diameter of a corresponding portion of the opening.

In another embodiment, a method of sealing a pharmaceutical container includes: inserting a pharmaceutical composition into the pharmaceutical container. The pharmaceutical container includes a shoulder, a neck extending from the shoulder, and a flange extending from the neck. The flange includes: an underside surface extending from the neck; an outer surface extending from the underside surface; and an upper surface opposite the underside surface. The upper surface extends between the outer surface and an inner surface defining an opening in the pharmaceutical container. The method further includes inserting a stopper through the opening in the pharmaceutical container to form a pharmaceutical container assembly. The stopper includes an upper portion and an insertion portion extending from the upper portion. The upper portion extends over the upper surface of the flange and covering the opening when in a sealed state. The insertion portion extends within the opening to define a seal between the insertion portion and the inner surface of the flange. The insertion portion includes an outer surface. Prior to inserting the stopper into the opening of the pharmaceutical container, in an unsealed state, an outer diameter of a portion of the insertion portion is equal to or greater than 3% and less than or equal to 15% greater than a diameter of a corresponding portion of the opening.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a cross-sectional view of a pharmaceutical container assembly in an unsealed state, according to one or more embodiments shown and described herein;

FIG. 2 schematically depicts a partial cross-sectional view of the pharmaceutical container in a sealed state and capped at a low residual seal force, according to one or more embodiments shown and described herein;

FIG. 3 schematically depicts a partially cross-sectional view of the pharmaceutical container in the sealed state and capped at a maximum residual seal force, according to one or more embodiments shown and described herein;

FIG. 4 schematically depicts a cross-sectional view of another pharmaceutical container assembly in a capped state, according to one or more embodiments shown and described herein;

FIG. 5 schematically depicts an enlarged cross-sectional view of the pharmaceutical container assembly of FIG. 4 taken from box 5 of FIG. 4, according to one or more embodiments shown and described herein;

FIG. 6 schematically depicts a cross-sectional view of another pharmaceutical container assembly in a sealed state, according to one or more embodiments shown and described herein;

FIG. 7 schematically depicts an enlarged cross-sectional view of the pharmaceutical container assembly of FIG. 6 taken from box 7 of FIG. 6, according to one or more embodiments shown and described herein;

FIG. 8 depicts a graph representing a relationship between interference fit and a required stopper insertion force, according to one or more embodiments shown and described herein; and

FIG. 9 depicts a graph representing a relationship between interference fit and oxygen concentration, according to one or more embodiments shown and described herein.

### DETAILED DESCRIPTION

Reference will now be made in detail to embodiments of pharmaceutical container assemblies including sealing assemblies that maintain container closure integrity at relatively low storage temperatures (e.g., less than or equal to −80 °C, less than or equal to −100 °C, less than or equal to −125 °C, less than or equal to −150 °C, less than or equal to −175 °C, less than or equal to 180 °C). In embodiments, the structure of the pharmaceutical container assemblies described herein may vary from that of existing pharmaceutical container assemblies in one or more respects to facilitate the maintenance of a seal at an interface between a pharmaceutical container and a sealing assembly inserted therein. For example, embodiments of pharmaceutical containers described herein may be vials (though other container shapes are within the scope of the present disclosure) including a shoulder, a neck, and a flange including an upper surface against which a stopper of a sealing assembly is pressed by a cap. Various characteristics of the pharmaceutical container and the sealing assembly, which cooperate to define a sealing surface, may be adapted to facilitate the maintenance of a seal when the pharmaceutical container assemblies are cooled to such low storage temperatures. For example, in embodiments, when in an unsealed state in which the sealing assembly is not inserted into the pharmaceutical container, an outer diameter of a portion of an insertion portion of the sealing assembly is equal to or greater than 3% and less than or equal to 15% greater than a diameter of a corresponding portion of the pharmaceutical container. In embodiments, various other characteristics of the sealing assembly (e.g., an outer diameter of an upper portion of the stopper, a geometry of an outer surface of the insertion portion, and the like) may be tailored to increase the sealing integrity.

As used herein, the term “container closure integrity” refers to maintenance of a seal at an interface between a pharmaceutical container and a sealing assembly (e.g., between an inner surface of a flange of the pharmaceutical container and an outer surface of an insertion portion of the stopper) that is free of gaps above a threshold size to maintain a probability of contaminant ingress or reduce the possibility of gas permeability below a predetermined threshold based on the material stored in a pharmaceutical container. For example, in embodiments, a container closure integrity is maintained if a helium leakage rate during a helium leak test described in USP <1207> (2016), particularly (<1207.1>, <1207.2>, and <1207.3>, is maintained at less than or equal to 1.4×10⁻⁶ cm³/s.

In the embodiments of the pharmaceutical containers described herein, the concentration of constituent components (e.g., SiO₂, Al₂O₃, B₂O₃ and the like) of the glass composition from which the pharmaceutical containers are formed are specified in mole percent (mol. %) on an oxide basis, unless otherwise specified.

The term “substantially free,” when used to describe the concentration and/or absence of a particular constituent component in a glass composition, means that the constituent component is not intentionally added to the glass composition. However, the glass composition may contain traces of the constituent component as a contaminant or tramp in amounts of less than 0.05 mol. %.

The term “CTE,” as used herein, refers to the coefficient of thermal expansion over a temperature range from about −200 °C to about 300 °C, unless stated otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the specific value or end-point referred to is included. Whether or not a numerical value or end-point of a range in the specification recites “about,” two embodiments are described: one modified by “about,” and one not modified by “about.” It will be further understood that the endpoints of each of the ranges are significant both in relation to the other endpoint, and independently of the other endpoint.

Directional terms as used herein—for example up, down, right, left, front, back, top, bottom, above, below—are made only with reference to the figures as drawn and are not intended to imply absolute orientation.

As used herein, the singular forms “a,” “an” and “the” include plural referents unless the context clearly dictates otherwise. Thus, for example, reference to “a” component includes aspects having two or more such components, unless the context clearly indicates otherwise.

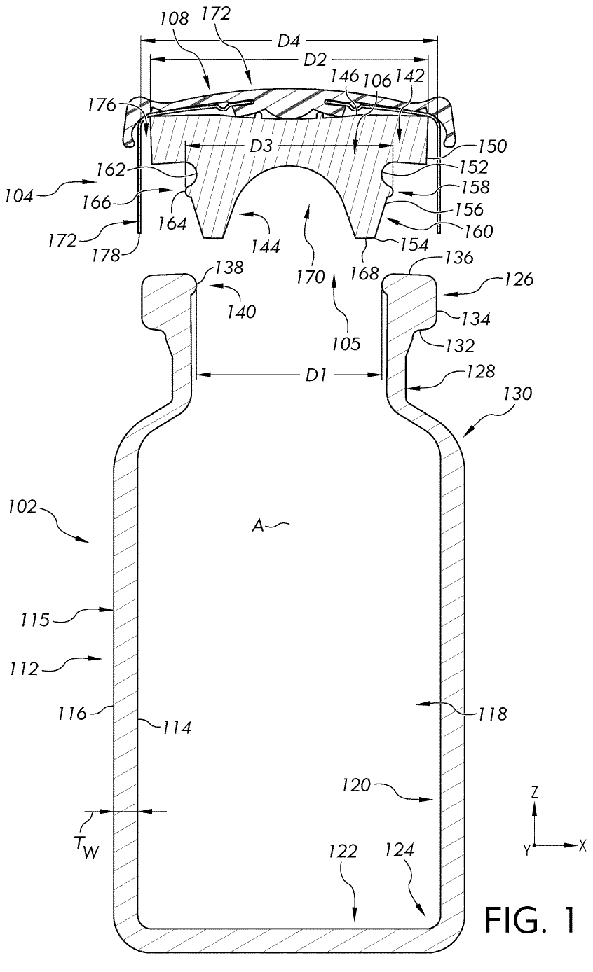

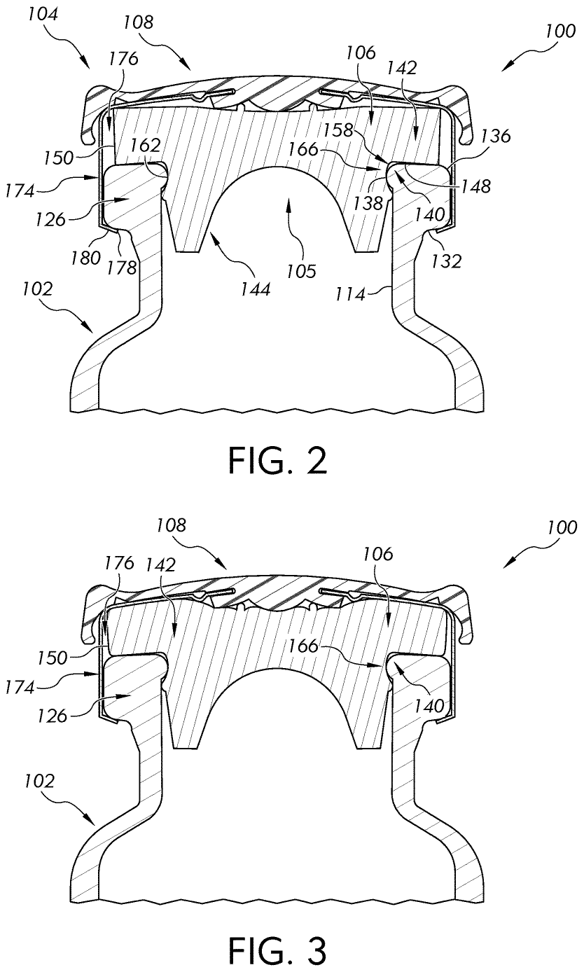

Referring now to FIGS. 1-3, one embodiment of a pharmaceutical container assembly 100 for storing a pharmaceutical formulation is schematically depicted in cross section. The pharmaceutical container assembly 100 comprises a pharmaceutical container 102 and a sealing assembly 104. The pharmaceutical container assembly 100 is depicted in an unsealed state in FIG. 1 in which the sealing assembly 104 is not inserted into the pharmaceutical container 102, and is partially depicted in a sealed state in FIGS. 2 and 3 in which the sealing assembly 104 is inserted into the pharmaceutical container 102. More particularly, as discussed in more detail herein, the pharmaceutical container assembly 100 is depicted in FIG. 2 in the sealed state and capped at a low residual seal force (RSF), e.g., equal to or greater than 2 pound force (lbf) and less than or equal to 10 lbf, and more particularly 5 lbf, and is depicted in FIG. 3 in the sealed state and capped at a maximum RSF, e.g., equal to or greater than 10 lbf and less than or equal to 20 lbf, and more particularly 15 lbf.

Referring again to FIG. 1, the pharmaceutical container 102 generally comprises a body 112. The body 112 has a wall thickness Tw, which extends between an inner surface 114 and an outer surface 116 of the pharmaceutical container 102, includes a central axis A, and generally encloses an interior volume 118. The wall thickness Tw of the pharmaceutical container 102 may vary depending on the implementation. In embodiments, the wall thickness Tw of the pharmaceutical container 102 may be from less than or equal to 6 millimeters (mm), such as less than or equal to 4 mm, less than or equal to 2 mm, less than or equal to 1.5 mm, or less than or equal to 1 mm. In some embodiments, the wall thickness T_{w} may be greater than or equal to 0.1 mm and less than or equal to 6 mm, greater than or equal to 0.3 mm and less than or equal to 4 mm, greater than or equal to 0.5 mm and less than or equal to 4 mm, greater than or equal to 0.5 mm and less than or equal to 2 mm, or greater than or equal to 0.5 mm and less than or equal to 1.5 mm. In embodiments, the wall thickness Tw may be greater than or equal to 0.9 mm and less than or equal to 1.8 mm. The wall thickness Tw may vary depending on the axial location within the pharmaceutical container 102.

In the embodiment of the pharmaceutical container 102 shown in FIG. 1, the body 112 generally includes a wall portion 120 and a floor portion 122. The wall portion 120 transitions into the floor portion 122 through a heel portion 124. In the depicted embodiment, the wall portion 120 of the pharmaceutical container 102 defines a flange 126, a neck 128 extending from the flange 126, a barrel 115, and a shoulder 130 extending between the neck 128 and the barrel 115. The floor portion 122 is coupled to the barrel 115 via the heel portion 124. In embodiments, the pharmaceutical container 102 is symmetrical about the central axis A, with each of the barrel 115, the neck 128, and the flange 126 being substantially cylindrical-shaped.

As depicted in FIG. 1, the flange 126 comprises an underside surface 132, an outer surface 134 extending from the underside surface 132, and an upper surface 136 opposite the underside surface 132. The inner surface 114 of the body 112 extends along each of the barrel 115, the flange 126, and the neck 128 and defines an opening 105 at the upper surface 136 of the flange 126

More particularly, in the embodiment of the pharmaceutical container 102 depicted in FIGS. 1-3, a lip 138 is formed on the inner surface 114 of the body 112 at the flange 126. As shown in FIG. 1, the lip 138 is depicted on opposite sides of the inner surface 114 of the body 112 at the flange 126. Accordingly, it should be appreciated that the lip 138 may be formed to extend along an entire circumference of the inner surface 114 of the body 112 or, in other embodiments, form a plurality of individual lip portions spaced apart from one another and formed at intervals along the circumference of the inner surface 114 of the body 112. The lip 138 prevents blowback of the sealing assembly 104 when being inserted into the opening 105 of the pharmaceutical container 102. The inner surface 114 of the body 112 extending along the flange 126 and the neck 128 from the lip 138 extends parallel to the central axis A. The inner surface 114 of the body 112 immediately below the lip 138 defines a flange seal location 140 having an inner diameter D1. As described in greater detail herein, the sealing assembly 104 contacts the flange seal location 140 when inserted within the pharmaceutical container 102 to define a seal between the sealing assembly 104 and the pharmaceutical container 102. However, in embodiments in which the lip 138 is not provided, it should be appreciated that the flange seal location 140 may be provided at any point of the inner surface 114 of the body 112 along the flange 126 or neck 128 that contacts the sealing assembly 104 when in the sealed state.

In embodiments, the pharmaceutical container 102 may be formed from Type I, Type II, or Type III glass as defined in USP <660>, including borosilicate glass compositions such as Type 1B borosilicate glass compositions under USP <660>. Alternatively, the pharmaceutical container 102 may be formed from alkali aluminosilicate glass compositions such as those disclosed in U.S. Pat. No. 8,551,898, hereby incorporated by reference in its entirety, or alkaline earth aluminosilicate glasses such as those described in U.S. Pat. No. 9,145,329, hereby incorporated by reference in its entirety. In embodiments, the pharmaceutical container 102 may be constructed from a soda lime glass composition. In embodiments, the pharmaceutical container 102 is constructed of a composition having a coefficient of thermal expansion that is greater than or equal to 0×10⁻⁷/K and less than or equal to 100×10⁻⁷/K (e.g., greater than or equal to 30×10⁻⁷/K and less than or equal to 70×10⁻⁷/K).

While the pharmaceutical container 102 is depicted in FIG. 1 as having a specific form-factor (i.e., a vial), it should be understood that, as discussed in more detail herein, the pharmaceutical container 102 may have other form factors, including, without limitation, Vacutainers®, cartridges, syringes, ampoules, bottles, flasks, phials, tubes, beakers, or the like. Further, it should be understood that the pharmaceutical containers described herein may be used for a variety of applications including, without limitation, as pharmaceutical packages, beverage containers, or the like.

Although referred to herein as a pharmaceutical container 102, it should be appreciated that the pharmaceutical container 102 may be formed of a material other than glass such as, for example, a polymer, metal, ceramic, and the like. Further, the coefficient of thermal expansion of these materials can be greater than or equal to 0×10⁻⁷/K and less than or equal to 8,000×10⁻⁷/K.

The sealing assembly 104 comprises a stopper 106 and a metal-containing cap 108. The stopper 106 comprises an upper portion 142 and an insertion portion 144 extending from the upper portion 142. In embodiments, the stopper 106 is constructed of a polymer-based material (e.g., butyl or other synthetic rubbers). The upper portion 142 comprises an upper surface 146, a lower surface 148 opposite the upper surface 146, and an outer surface 150 extending between the upper surface 146 and the lower surface 148. The outer surface 150 of the upper portion 142 defines an outer diameter D2.

The insertion portion 144 extends from the upper portion 142 in a direction opposite the upper surface 146 of the upper portion 142. The insertion portion 144 comprises an upper end 152 at the upper portion 142, a lower end 154 opposite the upper end 152, and an outer surface 156 extending between the upper end 152 and the lower end 154. The outer surface 156 of the insertion portion 144 includes an upper outer surface portion 158 and a lower outer surface portion 160. The upper outer surface portion 158 extends from the upper end 152 of the insertion portion 144, and the lower outer surface portion 160 extends from the upper outer surface portion 158 to the lower end 154 of the insertion portion 144. In embodiments in which the pharmaceutical container 102 includes the lip 138, as described herein, a groove 162 may be formed in the upper outer surface portion 158 of the insertion portion 144 at the upper end 152 of the insertion portion 144. In embodiments, the groove 162 may form a plurality of individual groove portions spaced apart from one another and formed at intervals along the circumference of the upper outer surface portion 158 of the insertion portion 144. In other embodiments, the groove 162 circumscribes the entire circumference of the insertion portion 144.

In embodiments, the insertion portion 144 comprises a protrusion 164 formed on the upper outer surface portion 158 of the insertion portion 144 where the upper outer surface portion 158 meets the lower outer surface portion 160. In embodiments, in which the groove 162 is provided, the protrusion 164 may be formed immediately below the groove 162 opposite the upper portion 142 of the stopper 106. However, it should be appreciated that the protrusion 164 may be provided at any location on the outer surface 156 of the insertion portion 144, such as on the lower outer surface portion 160. The protrusion 164 defines an insertion seal location 166 and has an outer diameter D3. The outer diameter D3 of the insertion seal location is greater than an outer diameter of the insertion portion at any other point along the outer surface of the insertion portion.

In the unsealed state in which the insertion portion 144 is not inserted into the opening 105 of the pharmaceutical container 102, as shown in FIG. 1, the outer diameter D3 of the insertion portion 144 defined by the protrusion 164 at the insertion seal location 166 is equal to or greater than 3% and less than or equal to 15% greater than the inner diameter D1 of the inner surface 114 of the body 112 at the flange seal location 140. In embodiments, the outer diameter D3 of the insertion portion 119 defined by the protrusion 164 at the insertion seal location 166 is equal to or greater than 5.8% and less than or equal to 13.5% greater than the inner diameter D1 of the inner surface 114 of the body 112 at the flange seal location 140. In embodiments, the outer diameter D3 of the insertion portion 144 defined by the protrusion 164 at the insertion seal location 166 is equal to or greater than 7% and less than or equal to 13% greater than the inner diameter D1 of the inner surface 114 of the body 112 at the flange seal location 140. In embodiments, the outer diameter D3 of the insertion portion 144 defined by the protrusion 164 at the insertion seal location 166 is equal to or greater than 9% and less than or equal to 11% greater than the inner diameter D1 of the inner surface 114 of the body 112 at the flange seal location 140. The percent different between the outer diameter D3 of the insertion portion 144 defined by the protrusion 164 at the insertion seal location 166 and the inner diameter D1 of the inner surface 114 of the body 112 at the flange seal location 140 may be referred to herein as an interference fit. Accordingly, the greater the percent difference between the outer diameter D3 of the insertion portion 144 and the inner diameter D1 of the inner surface 114 of the body 112, the greater the interference fit. Thus, the interference fit refers to the compression force against the insertion portion 144 of the stopper 106 caused by the pharmaceutical container 102 when the insertion portion 144 of the stopper 106 is inserted into the opening 105 of the pharmaceutical container 102.

In embodiments, the lower outer surface portion 160 of the insertion portion 144 tapers from the upper outer surface portion 158 toward the lower end 154 of the insertion portion 144. In embodiments in which the groove 162 and/or the protrusion 164 are not provided on the outer surface 134 of the insertion portion 144, the upper outer surface portion 158 of the insertion portion 144 may also taper from the upper end 152 to the lower outer surface portion 160, which may continue to taper toward the lower end 154 of the insertion portion 144.

The insertion portion 144 comprises a lower surface 168 at the lower end 154 of the insertion portion 144. In embodiments, a cutout 170 is formed in the lower surface 168 and extends in a direction toward the lower surface 148 of the upper portion 142. The cutout 170 may have any suitable shape such as, for example, a concave shape. However, it should be appreciated that the cutout 170 may have any other suitable shape such as, for example, tubular, rectangular, or the like.

Referring still to FIG. 1, the metal-containing cap 108 of the sealing assembly 104 comprises an upper portion 172 and a side portion 174 extending from the upper portion 172. The side portion 174 has an inner diameter D4. As shown in FIG. 1, with the sealing assembly 104 separated from the pharmaceutical container 102, the inner diameter D4 of the side portion 174 of the metal-containing cap 108 is greater than the outer diameter D2 of the upper portion 142 of the stopper 106 such that a gap 176 is defined therebetween. As referred to herein, the gap 176 refers to the outer surface 150 of the upper portion 142 of the stopper 106 not being in contact with the side portion 174 of the metal-containing cap 108. As described in more detail herein, the side portion 174 of the metal-containing cap 108, particularly a lower end 178 of the side portion 174, is deformable via crimping to engage the underside surface 132 of the flange 126, i.e., seal the sealing assembly 104 to the pharmaceutical container 102.

In embodiments, to maintain the seal, the metal-containing cap 108 and the stopper 106 may be constructed such that the shrinkage of the metal-containing cap 108 is greater than or equal to the combined shrinkage of the pharmaceutical container 102 and the stopper 106. To facilitate meeting such a relationship, in embodiments, the metal-containing cap 108 is constructed of aluminium, which may have a CTE of approximately 240×10⁻⁷/K. In other embodiments, the metal-containing cap is constructed of a metallic alloy comprising at least one of Zn, Mg, and Cu. Typical rubbers out of which the stopper 106 is constructed (e.g., Butyl 325, Butyl 035, etc.) may have CTEs of greater than or equal to 1,400×10⁻⁷/K. That is, purely in terms of CTE differential, the metal-containing cap 108 has a tendency to shrink less than the stopper 106, resulting in a diminished sealing force at lower storage temperature. In addition to the above-described CTE mismatch, the stopper 106 may make up a larger volumetric percentage of the sealing assembly 104 than the metal-containing cap 108, further compounding the tendency of the stopper 106 to undergo a larger thermal shrinkage.

Referring to FIG. 2, the pharmaceutical container assembly 100 is depicted in the sealed state and capped. Specifically, the sealing assembly 104 is coupled to the pharmaceutical container 102 at the opening 105 of the pharmaceutical container 102. When in the sealed state, the insertion portion 144 is inserted into the opening 105 of the pharmaceutical container 102 until the upper portion 142 contacts the upper surface 136 of the flange 126 of the pharmaceutical container 102. In the sealed state, the lower surface 148 of the upper portion 142 of the stopper 106 abuts the upper surface 136 of the flange 126 of the pharmaceutical container 102. Additionally, the lip 138 formed on the inner surface 114 of the pharmaceutical container 102 is received within the groove 162 formed on the upper outer surface portion 158 of the insertion portion 144. Accordingly, when in the sealed state, the flange seal location 140 and the insertion seal location 166 are aligned along the X-axis of the coordinate axes depicted in the figures and abut one another to define the seal. The inner surface 114 of the pharmaceutical container 102 compresses the insertion portion 144 of the stopper 106 at the flange seal location 140 and the insertion seal location 166 in accordance with the particular interference fit.

Thereafter, the upper portion 142 is then pressed against the upper surface 136 of the flange 126 via crimping of the metal-containing cap 108 to seal the sealing assembly 104 to the pharmaceutical container 102. During crimping, a compression force is applied to the metal-containing cap 108 and the pharmaceutical container 102 is capped by deforming the side portion 174 of the metal-containing cap 108 around the underside surface 132 of the flange 126 via any suitable crimping method (e.g., a pneumatic crimping apparatus or the like). Once crimped, the side portion 174 of the metal-containing cap 108 defines an underlying portion 180 at the lower end 178 of the side portion 174 that contacts the underside surface 132 of the flange 126 to force the stopper 106 to remain in a compressed state.

Compression of the stopper 106 generates an RSF within the flange 126 that maintains compression on the stopper 106 after the metal-containing cap 108 is crimped into place. Various aspects of the pharmaceutical container 102 and the sealing assembly 104 are designed to ensure maintenance of container closure integrity of the pharmaceutical container 102 at low storage temperatures of less than or equal to −80 °C, as described herein.

As shown in FIG. 2, the pharmaceutical container assembly 100 is depicted in the sealed state and capped at a low RSF such as, for example, 5 lbf. However, as shown in FIG. 2, the gap 176 formed between the outer surface 150 of the upper portion 142 of the stopper 106 and the side portion 174 of the metal-containing cap 108 is maintained. Accordingly, the outer surface 150 of the upper portion 142 of the stopper 106 does not contact the side portion 174 of the metal-containing cap 108.

Similarly, as shown in FIG. 3, the pharmaceutical container assembly 100 is depicted in the sealed state and capped at a maximum RSF such as, for example, 15 lbf. However, as shown in FIG. 3, the gap 176 formed between the outer surface 150 of the upper portion 142 of the stopper 106 and the side portion 174 of the metal-containing cap 108 is maintained despite compression of the stopper 106. Accordingly, the outer surface 150 of the upper portion 142 of the stopper 106 does not contact the side portion 174 of the metal-containing cap 108. It should be appreciated that without the gap 176 being provided between the upper portion 142 of the stopper 106 and the side portion 174 of the metal-containing cap 108, a failure mode may be created such that the seal formed between the sealing assembly 104 and the pharmaceutical container 102 would be compromised.

When the sealed and capped pharmaceutical container assembly 100 is cooled to relatively low storage temperatures of less than or equal to −80 °C (e.g., less than or equal to −80 °C, less than or equal to −100 °C, less than or equal to −125 °C, less than or equal to −150 °C, less than or equal to −175 °C, −180 °C), each of the constituent components of the pharmaceutical container assembly 100 may undergo a volumetric shrinkage that is dependent on the thermal properties of that component. If the combination of the stopper 106 shrinks in an amount that is greater than the amount of shrinkage of the flange 126, the compression on the stopper 106 provided by the flange 126 may diminish, increasing the probability of the seal formed at the flange seal location 140 and the insertion seal location 166 being broken. However, the increased interference fit, i.e., the outer diameter D3 of the insertion portion 144 being greater than the inner diameter D1 of the flange 126 when in the unsealed state (FIG. 1), permits greater shrinkage with reduced likelihood of the seal being broken.

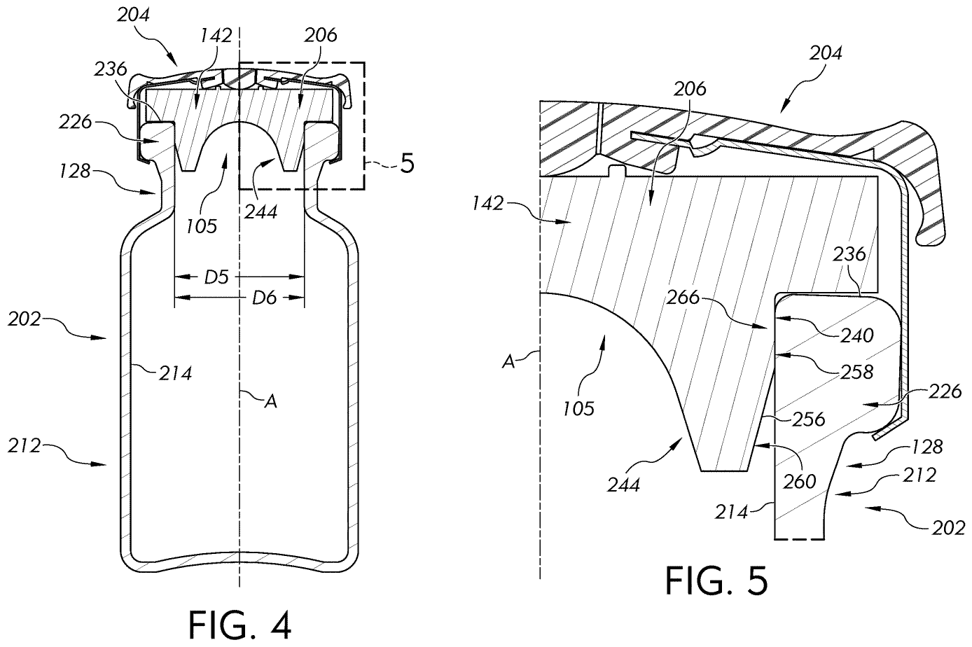

Although not illustrated herein, it should be understood that alternatives to the pharmaceutical container assembly 100 described herein with respect to FIGS. 1-3 may be used while still maintaining container closure integrity at storage temperatures less than or equal to −80 °C For example, another embodiment of a pharmaceutical container assembly 200 is depicted in FIGS. 4 and 5. It should be appreciated that the pharmaceutical container assembly 200 is similar to the pharmaceutical container assembly 100. As such, similar reference numbers will be used to refer to like parts.

As shown in FIGS. 4 and 5, the pharmaceutical container assembly 200 comprises a pharmaceutical container 202 and a sealing assembly 204. Similar to the pharmaceutical container 102 depicted in FIGS. 1-3, the pharmaceutical container 202 comprises a body 212 including a flange 226 and the neck 128 having an inner surface 214 extending therealong. However, the pharmaceutical container 202 does not include the lip 138 formed on the inner surface 214 of the pharmaceutical container 202 at the flange 226, as shown in the pharmaceutical container 102 depicted in FIGS. 1-3. Rather, the inner surface 214 of the pharmaceutical container 202 along the flange 226 and the neck 128 from an upper surface 236 of the flange 226 extends parallel to the central axis A. Thus, as shown with more particularity in FIG. 5, no lip is formed at a junction between the upper surface 236 of the flange 226 and the inner surface 214 of the pharmaceutical container 202 at the flange 226. Accordingly, an inner diameter D5 of the flange 226 defining the opening 105 is consistent, i.e., does not change, along the flange 226 and the neck 128 of the pharmaceutical container 202. In embodiments, the inner surface 214 extends substantially perpendicular from the upper surface 236 of the flange 226. In embodiments, the inner surface 214 extends at an angle from the upper surface 236 of the flange 226, the angle being equal to or less than 3 degrees relative to the upper surface 236 of the flange 226. The inner surface 214 of the pharmaceutical container 202 at the flange 226 defines a flange seal location 240.

The sealing assembly 204 comprises a stopper 206 including the upper portion 142 and an insertion portion 244 extending from the upper portion 142. As shown in FIG. 5, similar to the insertion portion 144 of the stopper 106 depicted in FIGS. 1-3, the insertion portion 244 comprises an outer surface 256 including an upper outer surface portion 258 and the lower outer surface portion 260 extending from the upper outer surface portion 258 in a direction opposite the upper portion 142 of the stopper 106. However, rather than the upper outer surface portion 258 including the groove 162 and the protrusion 164, as provided in the insertion portion 144 of the stopper 106 depicted in FIGS. 1-3, the upper outer surface portion 258 is planar such that it extends parallel to the central axis A of the pharmaceutical container 202. Accordingly, the outer diameter D6 of the insertion portion 244 is consistent, i.e., does not change, along the upper outer surface portion 258. The upper outer surface portion 258 of the insertion portion 244 defines an insertion seal location 266.

Similar to the pharmaceutical container assembly 100 depicted in FIGS. 1-3, in an unsealed state in which the insertion portion 244 is not inserted into the opening 105 of the pharmaceutical container 202, the outer diameter D6 of the insertion portion 244 at the insertion seal location 266 is equal to or greater than 3% and less than or equal to 15% greater than the inner diameter D5 of the inner surface 214 of the pharmaceutical container 202 at the flange seal location 240. In embodiments, the outer diameter D6 of the insertion portion 244 at the insertion seal location 266 is equal to or greater than 5.8% and less than or equal to 13.5% greater than the inner diameter D5 of the inner surface 214 of the pharmaceutical container 202 at the flange seal location 240. In embodiments, the outer diameter D6 of the insertion portion 244 at the insertion seal location 266 is equal to or greater than 7% and less than or equal to 13% greater than the inner diameter D5 of the inner surface 214 of the pharmaceutical container 202 at the flange seal location 240. In embodiments, the outer diameter D6 of the insertion portion 244 at the insertion seal location 266 is equal to or greater than 9% and less than or equal to 11% greater than the inner diameter D5 of the inner surface 214 of the pharmaceutical container 202 at the flange seal location 240. Although, the outer diameter D6 of the insertion portion 244 is depicted as being equal to the inner diameter D5 of the inner surface 214 in FIG. 4, it should be appreciated that the outer diameter D6 is greater than the inner diameter D5 when the sealing assembly 204 is not inserted into the opening 105 of the pharmaceutical container 202.

Thus, as shown in FIG. 5, in a sealed state in which the insertion portion 244 of the stopper 206 is inserted into the opening 105 of the pharmaceutical container 202, the upper outer surface portion 258 of the insertion portion 244 is compressed against and flush with the inner surface 214 of the pharmaceutical container 202 at the flange 226. Accordingly, the flange seal location 240 and the insertion seal location 266 abut against one another to define a seal between the sealing assembly 204 and the pharmaceutical container 202.

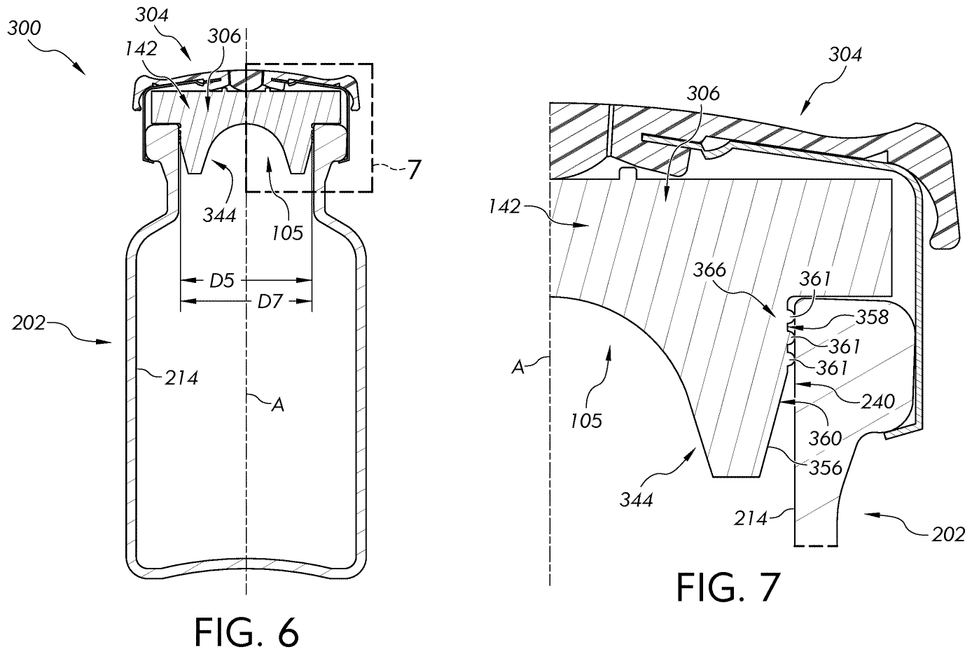

Referring to FIGS. 6 and 7, another embodiment of a pharmaceutical container assembly 300 is depicted. It should be appreciated that the pharmaceutical container assembly 300 is similar to the pharmaceutical container assemblies 100, 200. As such, similar reference numbers will be used to refer to like parts.

The pharmaceutical container assembly 300 comprises the pharmaceutical container 202 and a sealing assembly 304. The sealing assembly 304 comprises a stopper 306 including the upper portion 142 and an insertion portion 344 extending from the upper portion 142. As shown in FIG. 7, similar to the insertion portion 244 of the stopper 206 depicted in FIGS. 4 and 5, the insertion portion 344 comprises an outer surface 356 including an upper outer surface portion 358 and the lower outer surface portion 360 extending from the upper outer surface portion 358 in a direction opposite the upper portion 142 of the stopper 306. However, the insertion portion 344 includes one or more ribs 361 circumscribing the upper outer surface portion 358 of the insertion portion 344, which defines an insertion seal location 366 having an outer diameter D7. The insertion portion 344 includes any suitable number of ribs 361 such as, for example, one, two, three, or more than three ribs 361. As shown in FIG. 7, the insertion portion 344 includes three ribs 361 circumscribing the insertion portion 344. In embodiments, the ribs 361 are equidistantly spaced apart from one another in a vertical direction extending along the upper outer surface portion 358. Each rib 361 extends from the upper outer surface portion 358 the same distance. In other embodiments, the ribs 361 are spaced apart from one another at different intervals in the vertical direction such that the distance between each rib 261 is different. Each rib 361 extends from the upper outer surface portion 358 the same distance. As such, the ribs 361 define an insertion seal location 366.

Similar to the pharmaceutical container assemblies 100, 200 depicted in FIGS. 1-5, in an unsealed state in which the insertion portion 344 is not inserted into the opening 105 of the pharmaceutical container 302, the outer diameter D7 of the insertion portion 344 at the insertion seal location 366 is equal to or greater than 3% and less than or equal to 15% greater than the inner diameter D5 of the inner surface 214 of the pharmaceutical container 202 at the flange seal location 240. In embodiments, the outer diameter D7 of the insertion portion 344 at the insertion seal location 366 is equal to or greater than 5.8% and less than or equal to 13.5% greater than the inner diameter D5 of the inner surface 214 of the pharmaceutical container 202 at the flange seal location 240. In embodiments, the outer diameter D7 of the insertion portion 344 at the insertion seal location 366 is equal to or greater than 7% and less than or equal to 13% greater than the inner diameter D5 of the inner surface 214 of the pharmaceutical container 202 at the flange seal location 240. In embodiments, the outer diameter D7 of the insertion portion 344 at the insertion seal location 366 is equal to or greater than 9% and less than or equal to 11% greater than the inner diameter D5 of the inner surface 214 of the pharmaceutical container 202 at the flange seal location 240. Although, the outer diameter D7 of the insertion portion 344 is depicted as being equal to the inner diameter D5 of the inner surface 214 in FIG. 6, it should be appreciated that the outer diameter D7 is greater than the inner diameter D5 when the sealing assembly 304 is not inserted into the opening 105 of the pharmaceutical container 202.

Thus, as shown in FIG. 7, in a sealed state in which the insertion portion 344 of the stopper 306 is inserted into the opening 105 of the pharmaceutical container 202, the ribs 361 extending from the upper outer surface portion 358 of the insertion portion 344 are compressed against the inner surface 214 of the pharmaceutical container 202 at the flange 226. Accordingly, the flange seal location 240 and the insertion seal location 366 abut against one another to define a seal between the sealing assembly 304 and the pharmaceutical container 202. It should be appreciated that by providing the ribs 361, the amount of friction between the stopper 306 of the sealing assembly 304 and the pharmaceutical container 202 is reduced. However, the interference fit between the stopper 306 of the sealing assembly 304 and the pharmaceutical container 202 is unaffected.

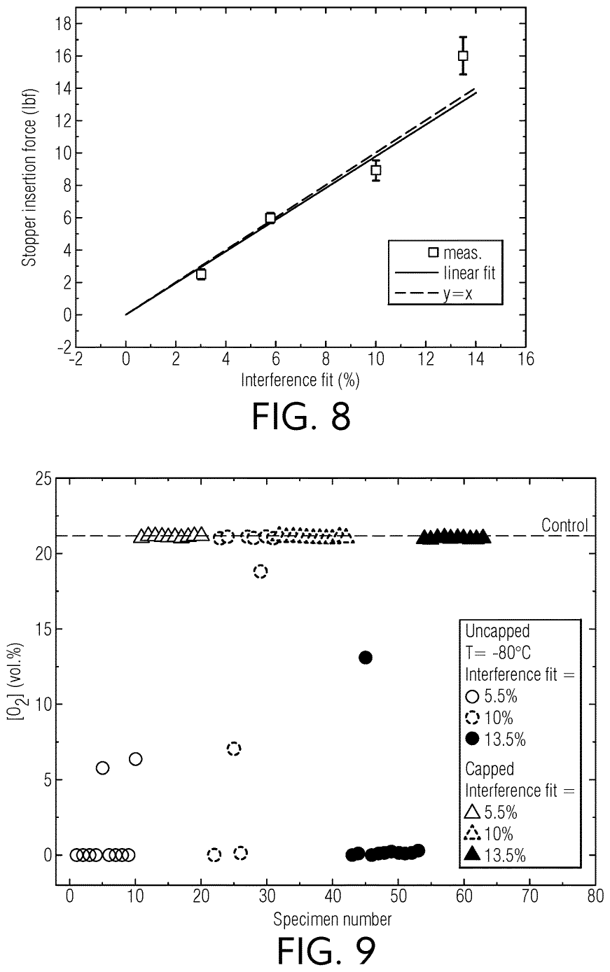

Referring now to FIG. 8, a chart depicting a relationship between stopper insertion force relative to interference fit is depicted. As referred to herein, the stopper insertion force is the force required to insert a stopper into an opening of a pharmaceutical container at a particular interference fit. Accordingly, as shown in FIG. 8, a plurality of measurements are taken at particular interference fits, for example, about 3%, about 6%, about 10%, and about 14%. As shown, the stopper insertion force at about 3% is about 2 lbf, the stopper insertion force at about 6% is about 6 lbf, the stopper insertion force at about 10% is about 8 lbf, and the stopper insertion force at about 14% is about 16 lbf. A linear fit line is then fitted to the measured data points to indicate the required stopper insertion force at each interference fit. Thus, it should be appreciated that with an increase interference fit, e.g., a stopper including an insertion portion having a larger outer diameter relative to an inner diameter of an opening of a pharmaceutical container, the greater the stopper insertion force required to insert the stopper into the opening of the pharmaceutical container.

As discussed herein, there is an optimal range of interference fit. For example, an interference fit of equal to or greater than 3% and less than or equal to 15% is preferred. An interference fit less than 3% is likely result in a failure occurring due to the stopper shrinking at a rate faster than the pharmaceutical container at relatively low temperatures. Additionally, an interference fit greater than 15% is likely to result in failure due to an outer surface of an upper portion of the stopper containing a side portion of a metal-containing cap during capping.

Referring now to FIG. 9, a chart depicting a relationship between oxygen concentration and interference fit is depicted. Specifically, a number of specimens, e.g., pharmaceutical container assemblies, were tested to identify container closure integrity pass rates at various stages of sealing, such as prior to capping with a metal-containing cap and after cap, as well as at various interference fits all at −80 °C. For example, as shown in FIG. 9, uncapped specimens with an interference fit of 5.5%, 10%, and 13.5% primarily exhibited an oxygen concentration of about 0%. However, capped specimens with an interference fit of 5.5%, 10%, and 13.5% primarily exhibited an oxygen concentration of about 21%. Although not depicted in FIG. 9, it should be appreciated that the uncapped specimens, i.e., a residual seal force of 0 lbf, having a 10% interference fit exhibited a 60% container closure integrity according to USP <1207>. However, the capped specimens having an interference fit between 5.8% and 13.5% exhibited a 100% container closure integrity according to USP <1207> independent of residual seal force.

From the above, it is to be appreciated that defined herein is a pharmaceutical container assembly including a pharmaceutical container and a sealing assembly. In a sealed state, an insertion portion of the sealing assembly is inserted into an opening of the pharmaceutical container to define a seal. In the sealed state, an upper portion of the sealing assembly extends over an upper surface of a flange of the pharmaceutical container and covers the opening. In an unsealed state in which the insertion portion is not inserted into the opening, an outer diameter of a portion of the insertion portion is equal to or greater than 3% and less than or equal to 15% greater than a diameter of a corresponding portion of the opening.

Further aspects of the embodiments described herein are provided by the subject matter of the following clauses:
Clause 1. A pharmaceutical container assembly comprising: a pharmaceutical container comprising: a shoulder; a neck extending from the shoulder; and a flange extending from the neck, the flange comprising: an underside surface extending from the neck; an outer surface extending from the underside surface; an upper surface opposite the underside surface, the upper surface extending between the outer surface and an inner surface defining an opening in the pharmaceutical container; and a sealing assembly comprising: a stopper comprising an upper portion and an insertion portion, the upper portion comprising an upper surface, the insertion portion comprising an outer surface, wherein: the insertion portion extends from the upper portion; in a sealed state, the insertion portion is inserted into the opening to define a seal between the insertion portion and the inner surface of the flange; in the sealed state, the upper portion extends over the upper surface of the flange and covers the opening; and in an unsealed state in which the insertion portion is not inserted into the opening, an outer diameter of a portion of the insertion portion is equal to or greater than 3% and less than or equal to 15% greater than a diameter of a corresponding portion of the opening.
Clause 2. The pharmaceutical container assembly of clause 1, further comprising: a metal-containing cap engaged with the stopper and securing the stopper to the flange when in the sealed state, wherein: the metal-containing cap comprises an upper portion and a side portion; the upper portion of the metal-containing cap abuts the upper surface of the upper portion of the stopper; the side portion of the metal-containing cap defines an inner diameter of the metal-containing cap; and the inner diameter of the metal-containing cap is greater than an outer diameter of the upper portion of the stopper such that a gap is disposed between an outer surface of the upper portion and the side portion of the metal-containing cap.
Clause 3. The pharmaceutical container assembly of clause 2, wherein, upon applying a compression force of equal to or greater than 5 pound-force (lbf) and less than or equal to 15 lbf, the side portion of the metal-containing cap remains spaced-apart from the outer surface of the upper portion of the stopper.
Clause 4. The pharmaceutical container assembly of clause 2 or clause 3, wherein the inner diameter of the side portion of the metal-containing cap is equal to or greater than 1% and less than or equal to 20% greater than the outer diameter of the upper portion of the stopper.
Clause 5. The pharmaceutical container assembly of clause 4, wherein the inner diameter of the side portion of the metal-containing cap is equal to or greater than 3% and less than or equal to 10% greater than the outer diameter of the upper portion of the stopper.
Clause 6. The pharmaceutical container assembly of any one of clauses 1-5, wherein: the upper portion of the stopper comprises a lower surface opposite the upper surface of the upper portion, and an outer surface extending between the upper surface and the lower surface; and the insertion portion extends from the lower surface of the upper portion in a direction away from the upper surface of the upper portion.
Clause 7. The pharmaceutical container assembly of clause 6, wherein a cutout is formed in a lower surface of the insertion portion and extends in a direction toward the lower surface of the upper portion.
Clause 8. The pharmaceutical container assembly of clause 6 or clause 7, wherein a groove is formed at an upper end of the insertion portion.
Clause 9. The pharmaceutical container assembly of clause 8, wherein the outer diameter of the insertion portion at a lower end of the groove is greater than the outer diameter of the insertion portion at a lower end of the insertion portion.
Clause 10. The pharmaceutical container assembly of clause 9, wherein the outer surface of the insertion portion includes a lower outer surface portion that tapers proximate the groove toward the lower end of the insertion portion.
Clause 11. The pharmaceutical container assembly of any one of clauses 8-10, wherein the groove circumscribes the insertion portion.
Clause 12. The pharmaceutical container assembly of any one of clauses 7-11, wherein the cutout has a concave shape.
Clause 13. The pharmaceutical container assembly of any one of clauses 1-12, wherein: the upper portion comprises a lower surface opposite the upper surface of the upper portion; the insertion portion extends from the lower surface of the upper portion in a direction away from the upper surface of the upper portion; and a plurality of ribs are formed on the outer surface of the insertion portion.
Clause 14. The pharmaceutical container assembly of clause 13, wherein the plurality of ribs are equidistantly spaced apart from one another.
Clause 15. The pharmaceutical container assembly of clause 13 or clause 14, wherein the plurality of ribs comprises three ribs.
Clause 16. The pharmaceutical container assembly of any one of clauses 1-15, wherein: the inner surface of the flange extending from the upper surface of the flange is planar and extends parallel to a central axis of the pharmaceutical container; and the outer surface of the insertion portion includes an upper outer surface portion that extends parallel to an abuts against the inner surface of the flange when in the sealed state.
Clause 17. The pharmaceutical container assembly of clause 16, wherein the inner surface of the flange extends substantially perpendicular from the upper surface of the flange.
Clause 18. The pharmaceutical container assembly of clause 17, wherein the upper outer surface portion of the insertion portion extends from a lower surface of the upper portion to a lower outer surface portion of the insertion portion that tapers from the upper outer surface portion.
Clause 19. The pharmaceutical container assembly of clause 18, wherein an outer diameter of the insertion portion at an upper end of the lower outer surface portion of the insertion portion is greater than an outer diameter of the insertion portion at a lower end of the insertion portion.
Clause 20. The pharmaceutical container assembly of any one of clauses 1-19, wherein, in the sealed state, the pharmaceutical container assembly has a container closure integrity pass rate of at least 60% according to USP <1207>.
Clause 21. A method of sealing a pharmaceutical container, the method comprising: inserting a pharmaceutical composition into the pharmaceutical container, the pharmaceutical container comprising a shoulder, a neck extending from the shoulder, and a flange extending from the neck, the flange comprising: an underside surface extending from the neck; an outer surface extending from the underside surface; and an upper surface opposite the underside surface, the upper surface extending between the outer surface and an inner surface defining an opening in the pharmaceutical container; and inserting a stopper through the opening in the pharmaceutical container to form a pharmaceutical container assembly, the stopper comprising an upper portion and an insertion portion extending from the upper portion, the upper portion extending over the upper surface of the flange and covering the opening when in a sealed state, the insertion portion extending within the opening to define a seal between the insertion portion and the inner surface of the flange, the insertion portion comprising an outer surface, wherein prior to inserting the stopper into the opening of the pharmaceutical container, in an unsealed state, an outer diameter of a portion of the insertion portion is equal to or greater than 3% and less than or equal to 15% greater than a diameter of a corresponding portion of the opening.
Clause 22. The method of clause 21, further comprising: crimping a metal-containing cap over the stopper and against the flange to compress the stopper against the upper surface, wherein: the metal-containing cap comprises an upper portion and a side portion; the upper portion of the metal-containing cap abuts an upper surface of the upper portion; the side portion of the metal-containing cap defines an inner diameter of the metal-containing cap; and the inner diameter of the metal-containing cap is greater than an outer diameter of the upper portion of the stopper such that a gap is disposed between an outer surface of the upper portion of the stopper and the side portion of the metal-containing cap.
Clause 23. The method of clause 22, wherein, upon applying a compression force of equal to or greater than 5 pound-force (lbf) and less than or equal to 15 lbf, the metal-containing cap remains spaced-apart from the outer surface of the upper portion of the stopper.
Clause 24. The method of clause 22 or clause 23, wherein the inner diameter of the side portion of the metal-containing cap is equal to or greater than 1% and less than or equal to 20% greater than the outer diameter of the upper portion of the stopper.
Clause 25. The method of clause 24, wherein the inner diameter of the side portion of the metal-containing cap is equal to or greater than 3% and less than or equal to 10% greater than the outer diameter of the upper portion of the stopper.
Clause 26. The method of any one of clauses 22-25, wherein: the inner surface of the flange extending from the upper surface of the flange is planar and extends parallel to a central axis of the pharmaceutical container; the insertion portion of the stopper extends from a lower surface of the upper portion in a direction away from the upper surface of the upper portion; and the outer surface of the insertion portion includes an upper outer surface portion that extends parallel to and abuts the inner surface of the flange when in the sealed state.
Clause 27. The method of clause 26, wherein the inner surface of the flange extends substantially perpendicular from the upper surface of the flange.
Clause 28. The method of clause 26 or clause 27, wherein the insertion portion comprises a plurality of ribs formed on the outer surface of the insertion portion, the plurality of ribs abutting the inner surface of the flange when in the sealed state.
Clause 29. The method of clause 28, wherein the plurality of ribs circumscribe the outer surface of the insertion portion.
Clause 30. The method of clause 28 or clause 29, wherein the plurality of ribs are equidistantly spaced apart from one another.
Clause 31. The method of clause 28 or clause 29, wherein a distance between each of the plurality of ribs is not equal.
Clause 32. The method of any one of clauses 28-31, wherein the plurality of ribs comprises three ribs.
Clause 33. The method of any one of clauses 21-32, wherein, in the sealed state, the pharmaceutical container assembly has a container closure integrity pass rate of at least 60% according to USP <1207>.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

1. A pharmaceutical container assembly comprising:
a pharmaceutical container comprising:
a shoulder;
a neck extending from the shoulder; and
a flange extending from the neck, the flange comprising:
an underside surface extending from the neck;
an outer surface extending from the underside surface;
an upper surface opposite the underside surface, the upper surface extending between the outer surface and an inner surface defining an opening in the pharmaceutical container;
a sealing assembly comprising:
a stopper comprising an upper portion and an insertion portion, the upper portion comprising an upper surface, the insertion portion comprising an outer surface, wherein:
the insertion portion extends from the upper portion;
in a sealed state, the insertion portion is inserted into the opening to define a seal between the insertion portion and the inner surface of the flange;
in the sealed state, the upper portion extends over the upper surface of the flange and covers the opening; and
in an unsealed state in which the insertion portion is not inserted into the opening, an outer diameter of a portion of the insertion portion is equal to or greater than 3% and less than or equal to 15% greater than a diameter of a corresponding portion of the opening; and
a metal-containing cap engaged with the stopper and securing the stopper to the flange when in the sealed state, wherein:
the metal-containing cap comprises an upper portion and a side portion:
the upper portion of the metal-containing cap abuts the upper surface of the upper portion of the stopper:
the side portion of the metal-containing cap defines an inner diameter of the metal-containing cap: and
the inner diameter of the metal-containing cap is greater than an outer diameter of the upper portion of the stopper such that a gap is disposed between an outer surface of the upper portion and the side portion of the metal-containing cap.

2. (canceled)

3. The pharmaceutical container assembly of claim 1, wherein, upon applying a compression force of equal to or greater than 5 pound-force (lbf) and less than or equal to 15 lbf, the gap is maintained between the outer surface of the upper portion of the stopper portion and the side portion of the metal-containing cap.

4. The pharmaceutical container assembly of claim 1, wherein the inner diameter of the side portion of the metal-containing cap is equal to or greater than 1% and less than or equal to 20% greater than the outer diameter of the upper portion of the stopper.

5. The pharmaceutical container assembly of claim 4, wherein the inner diameter of the side portion of the metal-containing cap is equal to or greater than 3% and less than or equal to 10% greater than the outer diameter of the upper portion of the stopper.

6. The pharmaceutical container assembly of claim 1, wherein:
the upper portion of the stopper comprises a lower surface opposite the upper surface of the upper portion, and an outer surface extending between the upper surface and the lower surface; and
the insertion portion extends from the lower surface of the upper portion in a direction away from the upper surface of the upper portion.

7. The pharmaceutical container assembly of claim 6, wherein a cutout is formed in a lower surface of the insertion portion and extends in a direction toward the lower surface of the upper portion.

8. The pharmaceutical container assembly of claim 6, wherein a groove circumscribes an upper end of the insertion portion.

9. The pharmaceutical container assembly of claim 8, wherein the outer diameter of the insertion portion at a lower end of the groove is greater than the outer diameter of the insertion portion at a lower end of the insertion portion.

10. The pharmaceutical container assembly of claim 9, wherein the outer surface of the insertion portion includes a lower outer surface portion that tapers proximate the groove toward the lower end of the insertion portion.

11. (canceled)

12. The pharmaceutical container assembly of claim 7, wherein the cutout has a concave shape.

13. The pharmaceutical container assembly of claim 1, wherein:
the upper portion comprises a lower surface opposite the upper surface of the upper portion;
the insertion portion extends from the lower surface of the upper portion in a direction away from the upper surface of the upper portion; and
a plurality of ribs are formed on the outer surface of the insertion portion.

14. The pharmaceutical container assembly of claim 13, wherein the plurality of ribs are equidistantly spaced apart from one another.

15. (canceled)

16. The pharmaceutical container assembly of claim 1, wherein:
the inner surface of the flange extending from the upper surface of the flange is planar and extends parallel to a central axis of the pharmaceutical container; and
the outer surface of the insertion portion includes an upper outer surface portion that extends parallel to an abuts against the inner surface of the flange when in the sealed state.

17. The pharmaceutical container assembly of claim 16, wherein the inner surface of the flange extends substantially perpendicular from the upper surface of the flange.

18. The pharmaceutical container assembly of claim 17, wherein the upper outer surface portion of the insertion portion extends from a lower surface of the upper portion to a lower outer surface portion of the insertion portion that tapers from the upper outer surface portion.

19. The pharmaceutical container assembly of claim 18, wherein an outer diameter of the insertion portion at an upper end of the lower outer surface portion of the insertion portion is greater than an outer diameter of the insertion portion at a lower end of the insertion portion.

20. The pharmaceutical container assembly of claim 1, wherein, in the sealed state, the pharmaceutical container assembly has a container closure integrity pass rate of at least 60% according to USP <1207>.

21. A method of scaling a pharmaceutical container, the method comprising:
inserting a pharmaceutical composition into the pharmaceutical container, the pharmaceutical container comprising a shoulder, a neck extending from the shoulder, and a flange extending from the neck, the flange comprising:
an underside surface extending from the neck;
an outer surface extending from the underside surface; and
an upper surface opposite the underside surface, the upper surface extending between the outer surface and an inner surface defining an opening in the pharmaceutical container; and
inserting a stopper through the opening in the pharmaceutical container to form a pharmaceutical container assembly, the stopper comprising an upper portion and an insertion portion extending from the upper portion, the upper portion extending over the upper surface of the flange and covering the opening when in a sealed state, the insertion portion extending within the opening to define a seal between the insertion portion and the inner surface of the flange, the insertion portion comprising an outer surface,
wherein prior to inserting the stopper into the opening of the pharmaceutical container, in an unsealed state, an outer diameter of a portion of the insertion portion is equal to or greater than 3% and less than or equal to 15% greater than a diameter of a corresponding portion of the opening; and
crimping a metal-containing cap engaged over the stopper and against the flange to compress the stopper against the upper surface, wherein:
the metal-containing cap comprises an upper portion and a side portion:
the upper portion of the metal-containing cap abuts the upper surface of the upper portion of the stopper;
the side portion of the metal-containing cap defines an inner diameter of the metal-containing cap: and
the inner diameter of the metal-containing cap is greater than an outer diameter of the upper portion of the stopper such that a gap is disposed between an outer surface of the upper portion and the side portion of the metal-containing cap.

22. (canceled)

23. The method of claim 21, wherein, crimping the metal-containing cap comprises applying a compression force of equal to or greater than 5 pound-force (lbf) and less than or equal to 15 lbf, such that the gap is maintained between the outer surface of the upper portion of the stopper and the side portion of the metal-containing cap.

24. (canceled)

25. The method of claim 21, wherein the inner diameter of the side portion of the metal-containing cap is equal to or greater than 3% and less than or equal to 10% greater than the outer diameter of the upper portion of the stopper.

26. The method of claim 21, wherein:
the inner surface of the flange extending from the upper surface of the flange is planar and extends parallel to a central axis of the pharmaceutical container;
the insertion portion of the stopper extends from a lower surface of the upper portion in a direction away from the upper surface of the upper portion; and
the outer surface of the insertion portion includes an upper outer surface portion that extends parallel to and abuts the inner surface of the flange when in the sealed state.

27. The method of claim 26, wherein the inner surface of the flange extends substantially perpendicular from the upper surface of the flange.

28. The method of claim 26, wherein the insertion portion comprises a plurality of ribs which circumscribe the outer surface of the insertion portion, the plurality of ribs abutting the inner surface of the flange when in the sealed state.

29. (canceled)

30. The method of claim 28, wherein the plurality of ribs are equidistantly spaced apart from one another.

31. The method of claim 28, wherein a distance between each of the plurality of ribs is not equal.

32. The method of claim 28, wherein the plurality of ribs comprises three ribs.

33. The method of claim 21, wherein, in the sealed state, the pharmaceutical container assembly has a container closure integrity pass rate of at least 60% according to USP <1207>.
